(19) United States
(12) Patent Application Publication
(10) Pub. No.: US 2026/0074101 A1
(43) Pub. Date: Mar. 12, 2026

(54) Fe-BASED NANOCRYSTALLINE ALLOY RIBBON, WOUND CORE, AND PRODUCTION METHODS THEREFOR

(71) Applicant: DAIDO STEEL CO., LTD., Nagoya-shi (JP)

(72) Inventors: Hiroyuki TAKABAYASHI, Nagoya-shi (JP); Yuya TOMITA, Nagoya-shi (JP); Chihiro FURUSHO, Nagoya-shi (JP)

(21) Appl. No.: 19/316,638

(22) Filed: Sep. 2, 2025

(30) Foreign Application Priority Data
Sep. 10, 2024 (JP) 2024-155523

(51) Int. Cl. H01F 1/153; C22C 38/00; C22C 38/02; C22C 38/12; C22C 38/16; H01F 3/04

(52) U.S. Cl. CPC H01F 1/15341; C22C 38/002; C22C 38/02; C22C 38/12; C22C 38/16; H01F 3/04

(57) ABSTRACT

An Fe-based nanocrystalline alloy ribbon, the ribbon including an uneven structure on a surface of the ribbon, in which the uneven structure includes at least one recessed portion that extends along a longitudinal direction of the ribbon and that has a depth of 3 μm or more, and the ribbon includes a magnetic domain that is formed along a width direction intersecting the longitudinal direction.

### CROSS-REFERENCE TO RELATED APPLICATIONS

This application is based on and claims priority under 35 USC 119 from Japanese Patent Application No. 2024-155523 filed on Sep. 10, 2024, the entire content of which is incorporated herein by reference.

### TECHNICAL FIELD

The present invention relates to an Fe-based nanocrystalline alloy ribbon, a wound core, and production methods therefor.

### BACKGROUND ART

As a kind of soft magnetic material used for a high frequency transformer or a choke coil, an amorphous alloy ribbon including an Fe-based alloy such as an Fe—Si-based alloy or nanocrystalline alloy ribbon including an Fe-based alloy such as an Fe—Si-based alloy is exemplified. In these soft magnetic alloy ribbons, in addition to having high magnetic properties such as a high saturation magnetic flux density, reducing an iron loss to a low level is also an important property. In this kind of soft magnetic alloy ribbon, annealing in a magnetic field has been used in the related art as one of methods for reducing the iron loss. By annealing in a magnetic field, uniaxial magnetic anisotropy is imparted to the soft magnetic alloy ribbon, and the iron loss is reduced.

As another methods for reducing the iron loss in the soft magnetic alloy ribbon, a method of forming an uneven structure in the alloy ribbon is also known. For example, Patent Literature 1 discloses an embodiment in which a plurality of laser irradiation mark rows are formed on a surface of an Fe-based amorphous alloy ribbon in a predetermined positional relationship. Patent Literature 1 describes that a magnetic domain is subdivided by the laser irradiation mark rows, which contributes to a reduction in iron loss.
Patent Literature 1: JP2020-127018A

### SUMMARY OF INVENTION

As described above, subjecting the soft magnetic alloy ribbon to anneal in a magnetic field and forming the uneven structure on the soft magnetic alloy ribbon independently contribute to the reduction in iron loss. Therefore, there is a possibility that the effect of reducing the iron loss is further enhanced by combining the annealing in a magnetic field and change in physical structure of the alloy ribbon such as the formation of the uneven structure. However, there is a room for consideration as to what mode should be adopted in order to combine the annealing in a magnetic field and the change in physical structure while achieving the two effects sufficiently high. In particular, in the case of forming a soft magnetic alloy ribbon into a predetermined product shape, including a case of forming into a wound core, there is a large room for consideration as to how the form of the annealing in a magnetic field and the physical structure, such as the uneven structure, to be imparted to the soft magnetic alloy ribbon can be combined to enhance the effect of reducing the iron loss and to enhance product production efficiency in relation to the product shape.

An object of the present invention is to provide an Fe-based nanocrystalline alloy ribbon capable of effectively reducing an iron loss, a wound core using the same, and production methods therefor.

In order to solve the above problems, an Fe-based nanocrystalline alloy ribbon, a wound core, and production methods therefor in the present invention have the following configurations.

[1] An Fe-based nanocrystalline alloy ribbon, the ribbon including an uneven structure on a surface of the ribbon,
in which the uneven structure includes at least one recessed portion that extends along a longitudinal direction of the ribbon and that has a depth of 3 μm or more, and
the ribbon includes a magnetic domain that is formed along a width direction intersecting the longitudinal direction.

[2] An Fe-based nanocrystalline alloy ribbon, the ribbon including an uneven structure on a surface of the ribbon,
in which the uneven structure has a maximum height roughness Rz of 3 μm or more in a width direction of the ribbon, and
the ribbon includes a magnetic domain that is formed along the width direction.

[3] The Fe-based nanocrystalline alloy ribbon according to [1] or [2], in which the magnetic domain is divided in the width direction by the uneven structure.

[4] A wound core including:
the Fe-based nanocrystalline alloy ribbon according to any one of [1] to [3] that is wound into an annular shape along the longitudinal direction of the ribbon.

[5] A wound core including: an Fe-based nanocrystalline alloy ribbon, in which
the wound core includes a region where the ribbon is continuous along a height direction of the wound core,
the region has a width of 2.5 mm or less, and
the wound core includes a magnetic domain that is formed along the height direction of the wound core.

[6] The wound core according to [5], having a height of 2.5 mm or less.

[7] A wound core including:
the wound core according to [5] or [6] as a unit core, in which
a plurality of the unit cores are stacked in a height direction of the wound core.

[8] The Fe-based nanocrystalline alloy ribbon according to any one of [1] to [3] in which the ribbon includes crystal grains having an average grain diameter of 30 nm or less, and the wound core according to any one of [4] to [7], in which the ribbon comprises crystal grains having an average grain diameter of 30 nm or less.

[9] A method for producing an Fe-based nanocrystalline alloy ribbon, the method including:
forming an uneven structure on a surface of an Fe-based amorphous alloy ribbon; and
holding the ribbon at a temperature that is (a Curie point—200° C.) or higher and lower than the Curie point while applying a magnetic field to the ribbon in a width direction intersecting a longitudinal direction of the ribbon,
in which the uneven structure includes at least one recessed portion that extends along the longitudinal direction of the ribbon and that has a depth of 3 μm or more.

[10] A method for producing an Fe-based nanocrystalline alloy ribbon, the method including:
forming an uneven structure on a surface of an Fe-based amorphous alloy ribbon; and
holding the ribbon at a temperature that is (a Curie point-200° C.) or higher and lower than the Curie point while applying a magnetic field to the ribbon in the width direction,
in which the uneven structure has a maximum height roughness Rz of 3 μm or more in a width direction of the ribbon.

[11] A method for producing a wound core, the method including:
winding an Fe-based amorphous alloy ribbon into an annular shape to form a wound core structure;
setting a width of a region where the ribbon is continuous along a height direction of the wound core structure to 2.5 mm or less; and
holding the wound core structure at a temperature that is (Curie point—200° C.) or higher and lower than the Curie point while applying a magnetic field to the wound core structure in the height direction.

The Fe-based nanocrystalline alloy ribbon having the above configuration [1] includes an uneven structure including at least one recessed portion that extends along the longitudinal direction of the ribbon. The magnetic domain is formed along the width direction intersecting a direction in which the recessed portion extends. This configuration can be obtained by forming, on a surface of the amorphous alloy ribbon, an uneven structure including at least one recessed portion that extends along the longitudinal direction of the ribbon, and performing annealing in a magnetic field with applying a magnetic field in the width direction, as defined in the production method in the above [9]. When the annealing in a magnetic field is performed with applying a magnetic field in a direction intersecting the direction in which the recessed portion extends, the magnetic domain develops in a direction intersecting the recessed portion. At this time, a magnetic pole is formed on a side surface portion of the recessed portion, and thus the magnetic domain is subdivided. By subdividing the magnetic domain, an abnormal eddy current loss is reduced and an iron loss is reduced in the alloy ribbon. In particular, when application direction of a magnetic field is set to the width direction of the ribbon, the formation of the magnetic pole at a location on an end portion of the width direction in the ribbon or at a location on the side surface portion of an uneven structure generated in a stripe shape along the longitudinal direction in the case of producing the alloy ribbon by using a single roll liquid quenching method can be effectively used for subdividing the magnetic domain. Therefore, a high effect of reducing the iron loss by subdividing the magnetic domain is obtained. Further, when the depth of the recessed portion is set to 3 μm or more, the effect of reducing the iron loss by subdividing the magnetic domain is particularly high. The Fe-based nanocrystalline alloy ribbon including the uneven structure that includes at least one of the recessed portion having a depth of 3 μm or more can be suitably used for forming a wound core, as in the above [4].

The Fe-based nanocrystalline alloy ribbon having the above configuration [2] includes an uneven structure having a predetermined size in the width direction of the ribbon. The magnetic domain is formed along the width direction in which the uneven structure is formed. This configuration can be obtained by forming the uneven structure in the width direction on a surface of the amorphous alloy ribbon, and performing annealing in a magnetic field with applying a magnetic field in the width direction, as defined in the production method in the above [10]. When the uneven structure has the maximum height roughness Rz having a sufficient magnitude in the width direction of the ribbon, the uneven structure exhibits the same effect as that of the recessed portion extending along the longitudinal direction of the ribbon or a protruding portion in the annealing in a magnetic field with applying a magnetic field in the width direction. That is, similar to the recessed portion in the above aspect [1], in the annealing in a magnetic field, the magnetic domain is subdivided and the iron loss is effectively reduced. When the maximum height roughness Rz of the uneven structure in the width direction is 3 μm or more, the effect of reducing the iron loss by subdividing the magnetic domain is particularly high. The Fe-based nanocrystalline alloy ribbon including the uneven structure having the maximum height roughness Rz of 3 μm or more can also be suitably used for forming a wound core, as in the above [4].

In the wound core having the above configuration [5], the width of the region where the ribbon is continuous along the height direction of the wound core is limited to 2.5 mm or less. The magnetic domain is formed along the height direction. This configuration can be obtained by winding an amorphous alloy ribbon into an annular shape to form a wound core structure, setting the width of the region where the ribbon is continuous along the height direction to 2.5 mm or less, and performing annealing in a magnetic field with applying a magnetic field in the height direction, as defined in the production method in the above [11]. When the continuity in the height direction of the wound core is limited and then uniaxial magnetic anisotropy with the height direction being an easy magnetization axis is imparted by the annealing in a magnetic field, the magnetic domain can develop in the height direction in a state where the magnetic domain is subdivided. At this time, when the region where the ribbon is continuous in the height direction is set to a small width of 2.5 mm or less, a high effect is obtained in subdividing the magnetic domain, and as a result, the iron loss can be effectively reduced. The height direction of the wound core structure formed by winding the amorphous alloy ribbon corresponds to a width direction of a raw material alloy ribbon. That is, the annealing in a magnetic field with applying a magnetic field in the height direction of the wound core structure corresponds to the annealing in a magnetic field with applying a magnetic field in the width direction of the ribbon in producing the alloy ribbon of the above [1] and [2]. If the magnetic field is applied in a circumferential direction of the wound core structure, industrial difficulties such as necessity of a special magnetic field application device are likely to occur, but the application of the magnetic field in the height direction can be relatively easily performed using a general device. The wound core can also be used as a composite core by stacking a plurality of wound cores as in the above aspect [7].

Here, as a method of reducing the width of the region where the ribbon is continuous along the height direction in the wound core to 2.5 mm or less, it is conceivable to set the height of the entire wound core to 2.5 mm or less, as in the above [6]. In this case, it is sufficient that the wound core structure is formed by winding an alloy ribbon having a width of 2.5 mm or less into an annular shape. As another method, it is sufficient that one or a plurality of recessed portions are formed along circumference of the wound core in a middle portion of the wound core in the width direction, and an interval between upper and lower end edges in the height direction and the recessed portion or an interval between the plurality of recessed portions is set to 2.5 mm or less. In this case, the wound core structure may be formed by winding an alloy ribbon including an uneven structure that includes at least one recessed portion extending along the longitudinal direction of the ribbon. The limitation of the height of the entire wound core and the formation of the recessed portion may be used in combination.

### BRIEF DESCRIPTION OF DRAWINGS

FIGS. 1A and 1B are perspective views each schematically illustrating a structure of an Fe-based nanocrystalline alloy ribbon according to an embodiment of the present invention. FIG. 1A illustrates a first embodiment in which a groove-shaped recessed portion is formed on a surface of the alloy ribbon, and FIG. 1B shows a second embodiment in which a surface roughness is imparted.

FIGS. 2A and 2B are plan views each schematically illustrating a magnetic domain distribution in the Fe-based nanocrystalline alloy ribbon subjected to annealing in a magnetic field. FIG. 2A illustrates the magnetic domain in the Fe-based nanocrystalline alloy ribbon according to the first embodiment. FIG. 2B illustrates a magnetic domain in an alloy ribbon having no uneven structure on the surface of the ribbon.

FIG. 3A is a perspective view schematically illustrating a structure of a wound core according to the first embodiment of the present invention. FIG. 3B is a perspective view illustrating a magnetic domain distribution of the wound core according to the first embodiment of the present invention.

FIG. 4A is a perspective view schematically illustrating a structure of a wound core according to a third embodiment of the present invention. FIG. 4B is a perspective view illustrating a magnetic domain distribution of the wound core according to the third embodiment of the present invention.

FIG. 5 is a magnetic domain observation image of a sample in Example C4. A observation field of view is 1 mm×1 mm.

### DESCRIPTION OF EMBODIMENTS

Hereinafter, an Fe-based nanocrystalline alloy ribbon, a wound core, and production methods therefor according to an embodiment of the present invention are described. In the present specification, various properties indicate values in the atmosphere at room temperature.

### [Fe-Based Nanocrystalline Alloy Ribbon and Production Method Therefor]

The Fe-based nanocrystalline alloy ribbon according to the embodiment of the present invention is formed as a ribbon of a soft magnetic Fe-based alloy containing nanocrystals. A component composition of the Fe-based alloy is not particularly limited, and examples of the Fe-based alloy to be a nanocrystalline alloy having good soft magnetic properties include an Fe—Si-based alloy, particularly an Fe—Si—B—Nb—Cu alloy.

### <Fe-Based Nanocrystalline Alloy Ribbon According to First Embodiment>

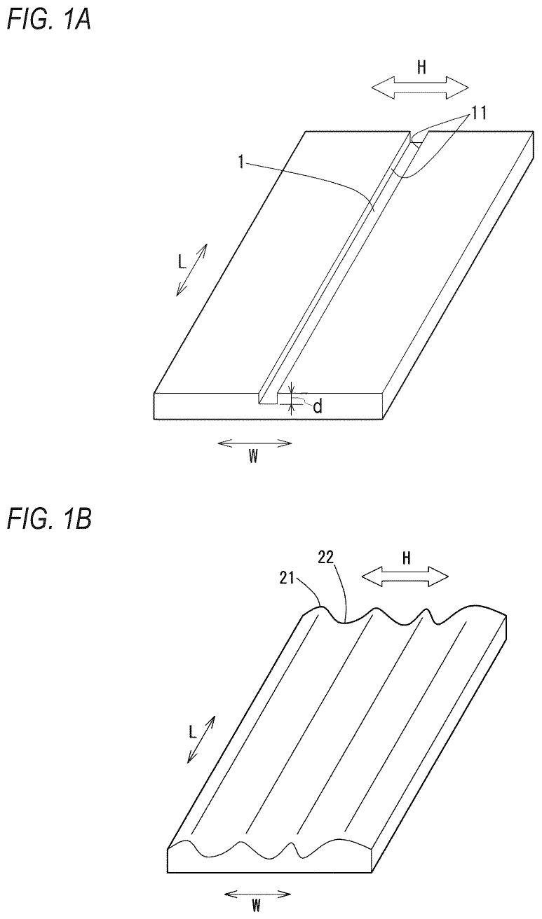

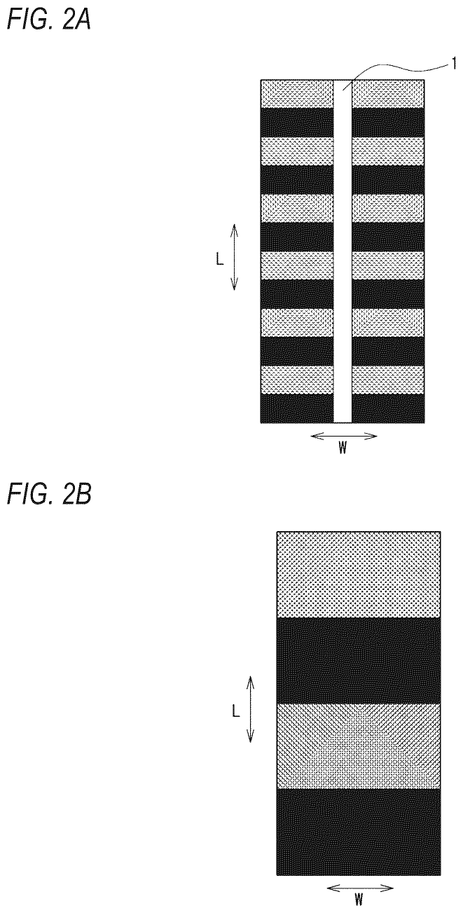

As shown in FIG. 1A, the Fe-based nanocrystalline alloy ribbon (hereinafter, may be simply referred to as an alloy ribbon or a ribbon) according to the first embodiment of the present invention includes an uneven structure on the surface of the alloy ribbon. The uneven structure is formed as a structure including at least one recessed portion 1 extending along a longitudinal direction L of the alloy ribbon. The recessed portion 1 has a depth (d) of 3 μm or more. Further, in the Fe-based nanocrystalline alloy ribbon, as shown in FIG. 2A, a magnetic domain is formed along a width direction W.

Here, the longitudinal direction L of the Fe-based nanocrystalline alloy ribbon is a direction along a long side of the elongated strip-shaped alloy ribbon, and corresponds to a casting direction corresponding to a rotation direction of a roll in the case of producing the alloy ribbon by using a single roll liquid quenching method to be described later. The width direction W is a direction along a short side of the alloy ribbon intersecting the longitudinal direction L, and is typically orthogonal to the longitudinal direction L. The recessed portion 1 extending along the longitudinal direction L indicates a state where the recessed portion 1 extends parallel to the longitudinal direction L. In addition, the magnetic domain being formed along the width direction W indicates a state where an elongated magnetic domain is formed such that a major axis is parallel to the width direction W. In the present specification, a state where the uneven structure or the magnetic domain is in parallel to a certain direction includes not only a state where the uneven structure or the magnetic domain is in strict parallel to a certain direction but also a state where the uneven structure or the magnetic domain is aligned parallel having an error range of about ±10° to the certain direction.

The Fe-based nanocrystalline alloy ribbon according to the present embodiment can be produced by using the following method. First, an Fe-based amorphous alloy ribbon having the same composition as that of the soft magnetic Fe-based alloy to be produced is prepared. For the preparation, a single roll liquid quenching method can be suitably used. That is, an amorphous alloy ribbon can be obtained by ejecting a molten alloy having a predetermined component composition onto a surface of a copper roll rotating at a high speed, and quenching and solidifying the molten alloy. Next, an uneven structure including at least one recessed portion 1 that has a depth of 3 μm or more is formed along the longitudinal direction L of the obtained amorphous alloy ribbon. The recessed portion 1 can be formed by laser processing, machining, etching, or the like. From the viewpoint of depth, controllability of the shape of the recessed portion 1, and the like, it is most preferable to use laser processing. The recessed portion 1 may be formed as a continuous structure along the longitudinal direction L, or may be formed as a structure in which a plurality of discontinuous recessed structures such as point-like recesses are arranged along the longitudinal direction L. The recessed portion 1 is preferably formed as a continuous structure. In addition, the recessed portion 1 is preferably formed over the entire region in the longitudinal direction L of the amorphous alloy ribbon excluding a region that cannot be inevitably formed.

Next, annealing in a magnetic field is performed on the amorphous alloy ribbon in which the uneven structure is formed. In the annealing in a magnetic field, as shown in FIG. 1A, while applying a magnetic field H to the ribbon in the width direction W, the ribbon is held at a temperature that is (a Curie point (Tc)—200° C.) or higher and less than the Curie point, that is the ribbon is held at a temperature T which satisfies (Tc—200° C.)≤T<Tc. The temperature is preferably (the Curie point (Tc)—200° C.) or higher and (the Curie point (Tc)—10° C.) or lower. The annealing in a magnetic field is preferably performed in an inert atmosphere such as an Ar atmosphere. As a strength of the magnetic field H, 0.01 T to 1 T can be exemplified.

The annealing in a magnetic field may be performed after performing a crystallization heat treatment on the amorphous alloy ribbon. The crystallization heat treatment is a step of heating the amorphous alloy ribbon without applying a magnetic field, and generation of the nanocrystalline alloy by crystallization of the amorphous alloy is promoted. For example, a treatment temperature in the crystallization heat treatment is preferably 450° C. to 600° C., and a heating rate up to the heat treatment temperature is preferably 0.1° C./min to 20° C./min. The heat treatment is also preferably performed in an inert atmosphere such as an Ar atmosphere.

By the annealing in a magnetic field, it is possible to impart uniaxial magnetic anisotropy with an application direction of the magnetic field H, that is, the width direction W, being an easy magnetization axis. At this time, as shown in FIG. 2A, a magnetic domain structure of the alloy ribbon changes. In FIG. 2A, adjacent magnetic domains that are antiparallel to each other are displayed in different colors. Each magnetic domain develops along the application direction of the magnetic field H. That is, each magnetic domain is formed along the width direction W, and the easy magnetization axis is directed in the width direction W. For comparison, FIG. 2B illustrates a magnetic domain distribution in the case where the annealing in a magnetic field is performed on a flat alloy ribbon with applying the magnetic field H in the width direction W without providing an uneven structure on the surface, and compared to this case, the magnetic domain is subdivided by providing an uneven structure on the surface. That is, a width of the magnetic domain along the longitudinal direction L of the alloy ribbon is reduced. The magnetic domain is subdivided by forming a magnetic pole on a side surface portion 11 (side wall surface of the groove) of the recessed portion 1 by applying the magnetic field H in a direction intersecting the recessed portion 1. The magnetic domain is subdivided along the longitudinal direction L of the alloy ribbon in this manner, and is also physically divided by the recessed portion 1 in the width direction W of the alloy ribbon. When the magnetic domain is subdivided in this manner, it is possible to reduce an abnormal current loss due to a domain-wall motion in applying an alternating magnetic field. Accordingly, an iron loss of the Fe-based nanocrystalline alloy ribbon can be reduced.

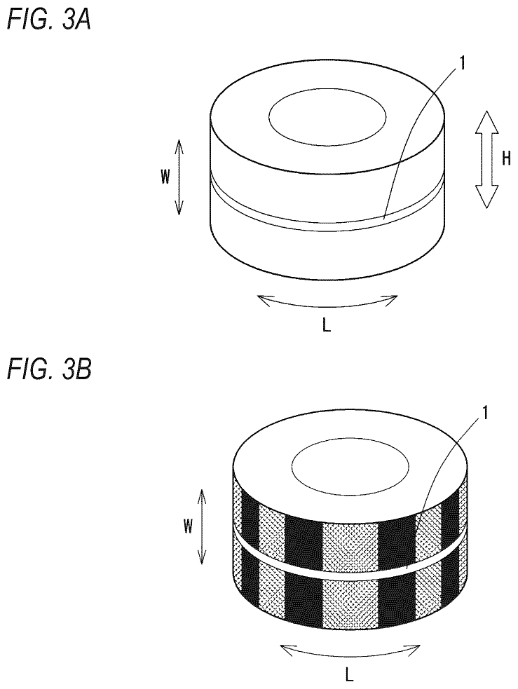

As described above, in the present embodiment, the nanocrystalline alloy ribbon is obtained by forming the uneven structure on the surface of the amorphous alloy ribbon and then performing the annealing in a magnetic field. In this manner, when the formation of the uneven structure and the annealing in a magnetic field are performed in combination, a high effect of reducing the iron loss is obtained. In particular, when a direction in which the recessed portion 1 extends is set to the longitudinal direction L of the alloy ribbon and the direction in which the magnetic field H is applied in the annealing in a magnetic field is set to the width direction W, a high effect of reducing the iron loss can be obtained. As described above, the magnetic domain is subdivided by forming the magnetic pole on the side surface portion 11 of the recessed portion 1. When the recessed portion 1 extends along the longitudinal direction L and the application direction of the magnetic field H is the width direction W, in addition to the formation of the magnetic pole on the side surface portion 11, formation of magnetic pole on a width direction end portion of the alloy ribbon (a location at both sides of end edges on width direction of the alloy ribbon) and formation of the magnetic pole on a side surface portion of an uneven structure generated during production of an alloy ribbon to be described later in a second embodiment can also contribute to subdividing the magnetic domain. In addition, when the magnetic field H is applied during the annealing in a magnetic field and the direction in which the magnetic domain develops is the width direction W of the alloy ribbon, it is possible to enhance convenience in producing many products to be produced using the Fe-based nanocrystalline alloy ribbon. For example, when a wound core is to be produced by winding the alloy ribbon into a annular shape along the longitudinal direction L of the alloy ribbon, the width direction W of the alloy ribbon corresponds to a height (thickness) direction of the core, and the application of a magnetic field in the height direction of the core can be more easily performed than the application of a magnetic field in a circumferential direction of the core corresponding to the longitudinal direction L of the alloy ribbon. Note that, in Patent Literature 1, as shown in FIGS. 3 and 8 of the Patent Literature 1, a laser irradiation mark row is formed along a width direction of an alloy ribbon or a direction close thereto. The annealing in a magnetic field is not performed in the Patent Literature 1.

Further, in the present embodiment, the depth of the recessed portion 1 provided along the longitudinal direction L of the alloy ribbon is 3 μm or more. Accordingly, the effect of reducing the iron loss by subdividing the magnetic domain can be further enhanced. The depth of the recessed portion 1 is preferably 5 μm or more, and more preferably 10 μm or more. There is no particular upper limit to the depth of the recessed portion 1.

The number of the recessed portions 1 is not particularly limited as long as it is one or more. In the case of providing only one recessed portion 1, it is preferable that the recessed portion 1 is provided at a center position of the width direction of the alloy ribbon. An interval of the recessed portions 1, that is, a distance along the width direction W between adjacent recessed portions 1 and a distance between an end edge on the width direction and a recessed portion 1 is not particularly limited, and is preferably 1 mm to 10 mm. The recessed portion 1 may be provided on only one surface of the alloy ribbon or may be provided on both surfaces of the alloy ribbon. The dimension of the alloy ribbon is not particularly specified, and a mode in which the thickness is 20 μm to 30 μm and a mode in which the width is 60 mm or less can be suitably exemplified.

As described above, when the Fe-based nanocrystalline alloy ribbon according to the present embodiment is to be produced, a structure of the nanocrystalline alloy is formed by performing the crystallization heat treatment and then performing the annealing in a magnetic field on the amorphous alloy ribbon provided with the recessed portion 1. As a grain diameter of crystal grains contained in the nanocrystalline alloy is smaller, higher soft magnetic properties are obtained. For example, an average crystal grain diameter in the nanocrystalline alloy ribbon is preferably 30 nm or less, and more preferably 20 nm or less. The crystal grain diameter can be controlled based on the conditions in the crystallization heat treatment and the like.

As described above, the Fe-based nanocrystalline alloy ribbon according to the present embodiment is excellent in effect of reducing the iron loss. For example, in the case of using an Fe—Si—B—Nb—Cu alloy, the iron loss (Pcv) at an applied magnetic field of 0.1 T and a frequency of 10 kHz can be reduced to 0.6 W/kg or less. In general, it is difficult to achieve both an improvement in saturation magnetic flux density and a reduction in iron loss in a soft magnetic material, but it is easy to achieve both a high saturation magnetic flux density and a small iron loss in the Fe-based nanocrystalline alloy ribbon according to the present embodiment. For example, in the case of using an Fe—Si—B—Nb—Cu alloy, a ratio Pcv/Bs of the iron loss (Pcv, unit: W/kg) to the saturation magnetic flux density (Bs, unit: T) measured under the above conditions can be reduced to less than 0.50, or even less than 0.40.

In the Fe-based nanocrystalline alloy ribbon according to the first embodiment of the present invention described above, the recessed portion 1 along the longitudinal direction L is provided as the uneven structure, and then the magnetic domain along the width direction W is formed, and by providing a sufficient unevenness difference along the width direction W of the alloy ribbon by the recessed portion 1, a high effect of reducing the iron loss is obtained. Not only when the recessed portion 1 along the longitudinal direction L is formed, but also when the uneven structure that gives a sufficient unevenness difference along the width direction W is provided on the surface of the alloy ribbon, a reduction in iron loss can be achieved through the annealing in a magnetic field with applying the magnetic field H along the width direction W. An Fe-based nanocrystalline alloy ribbon according to the second embodiment of the present invention is described below as an embodiment in which an uneven structure other than the recessed portion 1 is provided.

### <Fe-Based Nanocrystalline Alloy Ribbon According to Second Embodiment>

The Fe-based nanocrystalline alloy ribbon according to the second embodiment of the present invention includes, on the surface of the alloy ribbon, an uneven structure having a maximum height roughness Rz of 3 μm or more in the width direction W of the alloy ribbon, instead of the uneven structure including the recessed portion 1 along the longitudinal direction L of the alloy ribbon in the first embodiment of the Fe-based nanocrystalline alloy ribbon. A magnetic domain is formed along the width direction W of the alloy ribbon.

The uneven structure can be imparted as a surface roughness on the surface of the Fe-based nanocrystalline alloy ribbon. As the surface roughness, for example, as shown in FIG. 1B, a form in which the surface of the alloy ribbon has a height difference along the width direction W can be exemplified. Here, a location where the height of the surface is high and a location where the height of the surface is low each extend along the longitudinal direction L of the alloy ribbon, and a mountain-shaped location 21 and a valley-shaped location 22 are each formed along the longitudinal direction L. In this structure, a height difference between the highest point of the vertex of the mountain 21 and the lowest point of the bottom of the valley 22 on a straight line crossing the surface of the alloy ribbon along the width direction W is the maximum height roughness Rz. In this manner, the uneven structure in which the mountain 21 and/or the valley 22 each extend along the longitudinal direction L of the alloy ribbon is likely to be formed as a stripe shape structure along the longitudinal direction L corresponding to a rotation direction of a roll in the case of forming the alloy ribbon by using a single roll liquid quenching method.

The uneven structure in the Fe-based nanocrystalline alloy ribbon according to the first embodiment and the uneven structure in the Fe-based nanocrystalline alloy ribbon according to the second embodiment are common in that continuity of a metal material is divided in the width direction W by including an uneven along the width direction W of the alloy ribbon. Therefore, in the second embodiment of the Fe-based nanocrystalline alloy ribbon, similar to the first embodiment of the Fe-based nanocrystalline alloy ribbon, a structure in which the subdivided magnetic domain is formed along the width direction W can also be obtained by subjecting the amorphous alloy ribbon including an uneven structure on the surface to annealing in a magnetic field at a temperature that is (a Curie point—200° C.) or higher and less than the Curie point while applying the magnetic field H in the width direction W. Similar to the formation of the magnetic pole on the side surface portion 11 of the recessed portion 1 of the first embodiment contributing to subdividing the magnetic domain, in the second embodiment, the formation of a magnetic pole on a side surface portion of the uneven structure, that is, surfaces located on both sides in width direction among surfaces of the mountain 21 and/or the valley 22, also contributes to subdividing the magnetic domain. When the magnetic domain is subdivided, an abnormal eddy current loss of the alloy ribbon is reduced, and a high effect of reducing the iron loss is obtained. When the maximum height roughness Rz of the uneven structure in the width direction Wis 3 μm or more, the effect can be particularly enhanced. The Rz is preferably 5 μm or more. There is no particular upper limit to the Rz. The mountain 21 and/or the valley 22 that give an uneven structure is preferably formed over the entire region in the longitudinal direction L of the alloy ribbon excluding a region that cannot be inevitably formed. The uneven structure may also have a height difference in the longitudinal direction L of the alloy ribbon, and the maximum height roughness Rz in the longitudinal direction L is preferably smaller than the maximum height roughness Rz in the width direction W.

In the second embodiment of the Fe-based nanocrystalline alloy ribbon, the description of the configuration common to that of the first embodiment of the Fe-based nanocrystalline alloy ribbon is omitted, and the mechanism, the preferred structure, and the preferred physical property value described in the first embodiment of the Fe-based nanocrystalline alloy ribbon apply to the second embodiment of the Fe-based nanocrystalline alloy ribbon. Although any one of the uneven structure by the recessed portion in the first embodiment of the Fe-based nanocrystalline alloy ribbon and the uneven structure by the surface roughness in the second embodiment of the Fe-based nanocrystalline alloy ribbon may be adopted, the first embodiment is more excellent in that the formation position, the depth, and the like of the recessed portion are easily controlled. On the other hand, the second embodiment is more excellent in that uneven structures formed in various forms can be applied, such as by directly using a stripe-like structure formed during the production of the alloy ribbon as the uneven structure. An uneven structure including both the recessed portion in the first embodiment and the surface roughness in the second embodiment may be formed. For example, it is conceivable that a groove is further formed along the longitudinal direction L on the surface of the alloy ribbon including the uneven structure that has the maximum height roughness Rz of 3 μm or more in the width direction W.

### [Wound Core and Production Method Therefor]

A wound core according to an embodiment of the present invention includes an Fe-based nanocrystalline alloy ribbon. The alloy ribbon is wound into an annular shape over a plurality of layers to form a wound core (toroidal core). Similar to the above Fe-based nanocrystalline alloy ribbon, a component composition of the Fe-based alloy constituting the wound core is not particularly limited, and examples thereof include an Fe—Si-based alloy, particularly an Fe—Si—B—Nb—Cu alloy.

### <Wound Core According to First Embodiment and Wound Core According to Second Embodiment>

The wound core according to the first embodiment of the present invention includes the Fe-based nanocrystalline alloy ribbon according to the first embodiment of the present invention described above, that is, the Fe-based nanocrystalline alloy ribbon including the uneven structure that includes at least one recessed portion 1 extending along the longitudinal direction L. The wound core according to the second embodiment of the present invention includes the Fe-based nanocrystalline alloy ribbon according to the second embodiment of the present invention described above, that is, the Fe-based nanocrystalline alloy ribbon including the uneven structure that has a maximum height roughness Rz of 3 μm or more in the width direction W.

A structure of the wound core according to the first embodiment is shown in FIG. 3A. The wound cores according to the first embodiment and the second embodiment are formed by winding an Fe-based nanocrystalline alloy ribbon that includes a predetermined uneven structure in a multilayer annular shape along the longitudinal direction L. The width direction W of the alloy ribbon corresponds to the height direction of the wound core. Thus, as shown in FIG. 3B, the magnetic domain is formed along the height direction of the wound core corresponding to the width direction W. In the wound cores according to the first embodiment and the second embodiment, the dimension in the height direction of the entire wound core is not particularly limited, unlike a wound core according to a third embodiment to be described later.

The wound cores according to the first embodiment and the second embodiment can be produced by the following method. First, as described above, the Fe-based amorphous alloy ribbon including the uneven structure that includes the recessed portion 1 having a depth of 3 μm or more for the first embodiment or the Fe-based amorphous alloy ribbon including the uneven structure that has a maximum height roughness Rz of 3 μm or more in the width direction W for the second embodiment is produced. Then, the amorphous alloy ribbon is wound along the longitudinal direction L to form a wound core structure. Next, annealing in a magnetic field is performed on the wound core structure while applying the magnetic field H in the height direction. Before the annealing in a magnetic field, a crystallization heat treatment may be performed. The conditions in the annealing in a magnetic field and the crystallization annealing may be the same as those described above for the method for producing the Fe-based nanocrystalline alloy ribbon.

By performing the annealing in a magnetic field after performing the crystallization heat treatment, the structure of the alloy ribbon constituting the wound core, which has been amorphous, changes to a nanocrystalline alloy. As shown in FIG. 3B, the magnetic domain is formed along the height direction of the wound core, which is the direction in which the magnetic field H is applied. In the wound cores according to the first embodiment and the second embodiment, since the uneven structure is formed along the width direction W of the alloy ribbon, that is, the height direction of the wound core, the magnetic domain is subdivided, and it is possible to reduce an abnormal current loss due to a domain-wall motion in applying an alternating magnetic field, as described in the description for the Fe-based nanocrystalline alloy ribbon. This makes it possible to reduce the iron loss in the wound core. In the wound core, the application of the magnetic field in the height direction can be easily performed using a general magnetic field application device, unlike the application of the magnetic field in the circumferential direction. Therefore, the wound cores according to the first embodiment and the second embodiment also have excellent production efficiency.

### <Wound Core According to Third Embodiment>

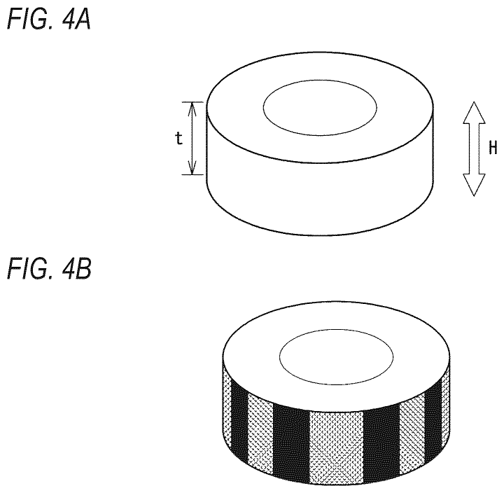

As shown in FIG. 4A, the wound core according to the third embodiment of the present invention has a height (thickness) t of 2.5 mm or less. Accordingly, a width of a region where the alloy ribbon is continuous along the height direction (thickness direction) of the wound core is limited to 2.5 mm or less. Further, in the wound core, as shown in FIG. 4B, a magnetic domain is formed along the height direction. Unlike the wound cores according to the first embodiment and the second embodiment described above, the wound core according to the third embodiment does not require the alloy ribbon constituting the wound core to include a specific uneven structure, and can include an Fe-based nanocrystalline alloy ribbon having any structure, including a ribbon substantially having no uneven structure.

The wound core according to the third embodiment can be produced by the following method. First, the Fe-based amorphous alloy ribbon is produced in the same manner as described above for the Fe-based nanocrystalline alloy ribbons according to the first embodiment and the second embodiment. However, it is not necessary to provide a specific uneven structure in the alloy ribbon. Next, the obtained alloy ribbon is wound in a multilayer annular shape along the longitudinal direction to form a wound core structure. At this time, by using an alloy ribbon having a width of less than 2.5 mm and setting the height t of the wound core structure to 2.5 mm or less, the width of the region where the alloy ribbon is continuous along the height direction of the wound core structure is limited to 2.5 mm or less. Next, annealing in a magnetic field is performed on the wound core structure. In the annealing in a magnetic field, the alloy ribbon is held at a temperature that is (a Curie point-200° C.) or higher and lower than the Curie point while applying the magnetic field H in the height direction of the wound core structure as shown in FIG. 4A. Before the annealing in a magnetic field, a crystallization heat treatment may be performed. Preferred conditions for the crystallization heat treatment and the annealing in a magnetic field may be the same as those described above for the Fe-based nanocrystalline alloy ribbons according to the first embodiment and the second embodiment.

By performing the annealing in a magnetic field after performing the crystallization heat treatment, the structure of the alloy ribbon constituting the wound core, which has been amorphous, changes to a nanocrystalline alloy. As shown in FIG. 4B, the magnetic domain is formed along the height direction of the wound core, which is the direction in which the magnetic field H is applied. In the wound core according to the third embodiment, since the height t is limited to be small, and a magnetic pole is formed at an end portion in the height direction of the wound core, the magnetic domain is subdivided. When the magnetic domain is subdivided, it is possible to reduce an abnormal current loss due to a domain-wall motion in applying an alternating magnetic field. Accordingly, an iron loss of the Fe-based nanocrystalline alloy ribbon can be reduced.

The height direction of the wound core corresponds to the width direction W of the alloy ribbon. Limiting the height t of the wound core to use the magnetic pole formed at the end portion in the height direction of the wound core is similar to providing the uneven structure along the width direction W of the alloy ribbon, that is, along the height direction of the wound core by forming a recessed portion and imparting a surface roughness to use the magnetic pole of a side surface portion of the uneven structure in the wound cores according to the first embodiment and the second embodiment in that the magnetic pole of the end portion of the alloy ribbon is used. Therefore, performing the annealing in a magnetic field with applying the magnetic field H in the height direction after limiting the height t of the wound core corresponds to performing the annealing in a magnetic field with applying the magnetic field H in the width direction W of the alloy ribbon after providing an uneven structure along the width direction W of the alloy ribbon. In the wound core according to the third embodiment, as described in the description for the Fe-based nanocrystalline alloy ribbons according to the first embodiment and the second embodiment, since the continuity of a magnetic metal portion in the height direction is limited, the magnetic domain is also effectively subdivided due to contribution of the formation of the magnetic pole at the height direction end portion, and a high effect of reducing the iron loss is also obtained. In addition, as described above, the application of the magnetic field in the height direction of the wound core can be easily performed, and it is not necessary to provide a specific uneven structure in the alloy ribbon, and thus the wound core according to the third embodiment has particularly excellent production efficiency.

In the wound core according to the third embodiment, when the height t is limited to 2.5 mm or less, a particularly high effect of reducing the iron loss by subdividing the magnetic domain is obtained. The height t of the wound core is more preferably 2.0 mm or less. In the wound core according to the third embodiment, the width of the region where the alloy ribbon is continuous along the height direction of the wound core is sufficiently limited to 2.5 mm or less, and setting the height t of the entire wound core to 2.5 mm or less is a simple means therefor, but other means are also conceivable. For example, an annular recessed portion along the circumferential direction of the wound core may be formed in a middle portion of the wound core in the height direction. A distance between upper and lower end edges in the height direction and the recessed portion or between a plurality of recessed portions is sufficiently 2.5 mm or less. The recessed portion is preferably formed along the longitudinal direction in the alloy ribbon before forming the wound core structure. In this case, the depth of the recessed portion is preferably 3 μm or more. The limitation of the height t of the entire wound core and the formation of the recessed portion along the circumferential direction may be used in combination. In addition, a composite wound core may be formed by stacking a plurality of unit cores along the height direction, each of the unit cores including a wound core including a region having the width of 2.5 mm or less where the alloy ribbon is continuous in the height direction, for example, a wound core having a height t of 2.5 mm or less. In this case, as described above, the effect of reducing the iron loss by subdividing the magnetic domain is similarly obtained. In addition, the preferred physical properties and the metal structure of the wound core according to the third embodiment are the same as those described in detail for the Fe-based nanocrystalline alloy ribbons according to the first embodiment and the second embodiment.

### EXAMPLES

Hereinafter, the present invention is described more specifically with reference to Examples. Note that, the present invention is not limited by these Examples.

### [Preparation of Sample]

A groove-formed sample, a roughness-imparted sample, and a core-height-limited sample were prepared as samples. The groove-formed sample corresponds to the Fe-based nanocrystalline alloy ribbon according to the first embodiment described above and the wound core according to the first embodiment described above, and the wound core of the groove-formed sample is a wound core including an Fe-based nanocrystalline alloy ribbon in which a groove-shaped recessed portion is formed along the longitudinal direction of the alloy ribbon. The roughness-imparted sample to the Fe-based nanocrystalline alloy ribbon according to the second embodiment described above and the wound core according to the second embodiment described above, and the wound core of the roughness-imparted sample is a wound core including an Fe-based nanocrystalline alloy ribbon to which a surface roughness having a predetermined maximum height roughness Rz in the width direction is imparted. The core-height-limited sample corresponds to the wound core according to the third embodiment described above, and is a wound core whose dimension in the height direction is limited.

As a raw material common to the samples, an alloy ribbon prepared by using a single roll liquid quenching method was used. The alloy kind constituting the alloy ribbon was any of the following four kinds. The alloy composition of each alloy kind is described in atom % as follows. An alloy 1 was mainly used. The thickness of each alloy ribbon was 18 μm.
Alloy 1: Fe74.5-Si13.5-B8-Nb3-Cu1, Curie point: 572° C.
Alloy 2: Fe73.5-Si14.5-B8-Nb3-Cu1, Curie point: 567° C.
Alloy 3: Fe72-Si16-B8-Nb3-Cu1, Curie point: 565° C.
Alloy 4: Fe70-Si18-B8-Nb3-Cu1, Curie point: 555° C.

Regarding the groove-formed sample, one groove-shaped recessed portion having a predetermined depth was formed along the longitudinal direction at a center position in the width direction of an alloy ribbon having a width of 10 mm. The groove was formed mainly by laser processing, but some samples were formed by machining or etching. As the laser processing, a femtosecond laser was used to form a recessed portion having a width of 10 μm. The depth of the recessed portion was adjusted based on laser intensity. As the machining, a diamond pen was pressed against the surface of the alloy ribbon to form a recessed portion. The depth of the recessed portion was controlled based on a load of pressing the diamond pen. The etching was performed by photo etching. In any case, the formation of the recessed portion was performed on a free surface (the surface not in contact with a roll during quenching) of the alloy ribbon, and the maximum height roughness Rz in the width direction at locations other than the location where the recessed portion was formed was less than 0.5 μm.

Regarding the roughness-imparted sample, an alloy ribbon having a predetermined maximum height roughness Rz in the width direction obtained by imparting a surface roughness to the surface of the alloy ribbon having a width of 10 mm was used. The imparting of the surface roughness and the adjustment of the Rz were performed by adjusting production conditions such as a roll peripheral speed and a differential pressure during production of the quenched ribbon. The Rz was measured by using a white interferometer.

Regarding the core-height-limited sample, an alloy ribbon having no uneven structure was directly used as a raw material of the wound core. At this time, in order to change the height of the wound core, a plurality of alloy ribbons having different widths were prepared.

For each sample, the alloy ribbon prepared above was wound in an annular shape along the longitudinal direction of the alloy ribbon to prepare a wound core structure. The wound core structure had an outer diameter of 28 mm and an inner diameter of 20 mm. The height of the wound core structure was 10 mm for the groove-formed sample and the roughness-imparted sample. The height of the wound core structure was as shown in Table 1 for the core-height-limited sample.

Next, the crystallization heat treatment and the annealing in a magnetic field were performed on the wound core structures for each sample. As the crystallization heat treatment, the wound core structure was heated to 570° C. at a heating rate of 5° C./min and then held at 570° C. for 1 hour. The annealing in a magnetic field was performed by holding the wound core structure at a holding temperature shown in Table 1 for 60 minutes with applying a magnetic field in the height direction of the wound core in a magnetic field having a magnetic flux density of 0.1 T. The crystallization heat treatment and the annealing in a magnetic field were continuously performed in an Ar atmosphere, followed by cooling. In this manner, wound core samples were prepared. In addition, for each sample, a ribbon-shaped sample obtained by subjecting the alloy ribbon in a state before being processed into the wound core structure to the crystallization heat treatment and the annealing in a magnetic field under the same conditions as described above was also prepared. The application direction of the magnetic field was the width direction of the alloy ribbon.

### [Evaluation Method]

Each of the samples prepared above was evaluated as follows. The evaluation was performed at room temperature.

### (1) Evaluation of Crystal Grain Diameter

The crystal grain diameter of each ribbon-shaped sample was evaluated by X-ray diffraction measurement. In the obtained diffraction pattern, the average grain diameter of the crystal grains was calculated based on the width of a peak corresponding to a (110) plane of a body-centered cubic structure (α phase) of Fe.

### (2) Evaluation of Magnetic Properties

The saturation magnetic flux density and the iron loss were measured for each wound core sample. Regarding the saturation magnetic flux density (Bs), a B-H curve at a maximum magnetic field Hm=800 A/m was acquired using a DC magnetization property test device, and the value of the magnetic flux density at H=800 A/m was recorded as the saturation magnetic flux density (Bs). The iron loss was evaluated by performing AC B-H measurement at an applied magnetic flux density of 0.1 T and a frequency of 10 kHz. Further, a ratio Pcv/Bs of the obtained iron loss (Pcv, unit: W/kg) to the saturation magnetic flux density (Bs, unit: T) was calculated. When Pcv/Bs is less than 0.50, it can be considered that both a high saturation magnetic flux density and a low iron loss can be achieved.

### (3) Checking of Magnetic Domain Distribution

As a representative, a sample in Example C4 formed as the roughness-imparted sample was subjected to magnetic domain observation. The magnetic domain observation was performed on the ribbon-shaped sample using a Kerr effect microscope.

### [Test Results]

Table 1 shows the configuration and production conditions of the samples and the results of the evaluation of the magnetic properties for each of Examples and Comparative Examples. Note that, the crystal grain diameter was 14.0 nm or more and 14.5 nm or less for all the samples.

TABLE 1

| | | | Groove | | Maximum height | Core |
|---|---|---|---|---|---|---|
| | | | processing | Groove | roughness Rz | height |
| Sample No. | Alloy kind | Sample kind | method | depth | [μm] | [mm] |
| Comparative | Alloy 1 | Unprocessed ribbon | — | — | <0.5 | — |
| Example 0 | | | | | | |
| Comparative | Alloy 1 | Groove-formed | Laser processing | 1.2 | <0.5 | |
| Example A1 | | | | | | |
| Comparative | | | | 2.1 | <0.5 | |
| Example A2 | | | | | | |
| Example A1 | | | | 3.1 | <0.5 | |
| Example A2 | | | | 4.5 | <0.5 | |
| Example A3 | | | | 5.2 | <0.5 | |
| Example A4 | | | | 7.5 | <0.5 | |
| Example A5 | | | | 10.9 | <0.5 | |
| Example A6 | | | | 14.8 | <0.5 | |
| Comparative | Alloy 1 | Roughness- | — | — | 1.0 | — |
| Example B1 | | imparted | | | | |
| Comparative | | | | | 2.1 | |
| Example B2 | | | | | | |
| Comparative | | | | | 2.4 | |
| Example B3 | | | | | | |
| Example B1 | | | | | 3.1 | |
| Example B2 | | | | | 4.3 | |
| Example B3 | | | | | 5.2 | |
| Example B4 | | | | | 5.3 | |
| Example B5 | | | | | 6.1 | |
| Comparative | Alloy 1 | Groove-formed | Laser processing | 4.8 | <0.5 | — |
| Example C1 | | | | | | |
| Example C1 | | | | 5.2 | <0.5 | |
| Example C2 | | | | 5.0 | <0.5 | |
| Example C3 | | | | 5.0 | <0.5 | |
| Example C4 | | | | 5.2 | <0.5 | |
| Comparative | | | | 5.1 | <0.5 | |
| Example C2 | | | | | | |
| Comparative | | | | 5.0 | <0.5 | |
| Example C3 | | | | | | |
| Example D1 | Alloy 1 | Groove-formed | Machining | 5.3 | <0.5 | — |
| Example D2 | | | Etching | 5.0 | <0.5 | |
| Example E1 | Alloy 1 | Core-height-limited | — | — | <0.5 | 2.0 |
| Example E2 | | | | | <0.5 | 2.5 |
| Comparative | | | | | <0.5 | 4.0 |
| Example E1 | | | | | | |
| Comparative | | | | | <0.5 | 5.0 |
| Example E2 | | | | | | |
| Comparative | | | | | <0.5 | 7.5 |
| Example E3 | | | | | | |
| Comparative | Alloy 2 | Groove-formed | Laser processing | 5.0 | <0.5 | — |
| Example F1 | | | | | | |
| Example F1 | | | | 4.8 | <0.5 | |
| Comparative | Alloy 3 | | | 4.9 | <0.5 | |
| Example F2 | | | | | | |
| Example F2 | | | | 4.9 | <0.5 | |
| Comparative | Alloy 4 | | | 4.9 | <0.5 | |
| Example F3 | | | | | | |
| Comparative | | | | 5.0 | <0.5 | |
| Example F4 | | | | | | |
| Example F3 | | | | 5.0 | <0.5 | |

| | Holding temperature during annealing in | | | | |
|---|---|---|---|---|---|
| | magnetic field | | Magnetic properties | | |
| | | Difference from Tc | Magnetic flux | Iron loss Pcv | |
| Sample No. | Temperature [° C.] | [° C.] | Bs [T] | [W/kg] | Pcv/Bs |
| Comparative Example | 550 | −22 | 1.13 | 0.58 | 0.51 |
| 0 | | | | | |
| Comparative Example | 550 | −22 | 1.14 | 0.58 | 0.51 |
| A1 | | | | | |
| Comparative Example | | | 1.14 | 0.59 | 0.52 |
| A2 | | | | | |
| Example A1 | | | 1.13 | 0.50 | 0.44 |
| Example A2 | | | 1.13 | 0.49 | 0.43 |
| Example A3 | | | 1.13 | 0.48 | 0.42 |
| Example A4 | | | 1.14 | 0.46 | 0.40 |
| Example A5 | | | 1.14 | 0.47 | 0.41 |
| Example A6 | | | 1.13 | 0.45 | 0.40 |
| Comparative Example | 550 | −22 | 1.14 | 0.58 | 0.50 |
| B1 | | | | | |
| Comparative Example | | | 1.14 | 0.59 | 0.52 |
| B2 | | | | | |
| Comparative Example | | | 1.14 | 0.58 | 0.51 |
| B3 | | | | | |
| Example B1 | | | 1.14 | 0.49 | 0.43 |
| Example B2 | | | 1.14 | 0.48 | 0.42 |
| Example B3 | | | 1.14 | 0.46 | 0.40 |
| Example B4 | | | 1.14 | 0.47 | 0.41 |
| Example B5 | | | 1.14 | 0.45 | 0.40 |
| Comparative Example | 350 | −222 | 1.14 | 0.66 | 0.58 |
| C1 | | | | | |
| Example C1 | 400 | −172 | 1.13 | 0.52 | 0.46 |
| Example C2 | 450 | 122 | 1.13 | 0.45 | 0.39 |
| Example C3 | 550 | −22 | 1.13 | 0.51 | 0.45 |
| Example C4 | 560 | −12 | 1.14 | 0.52 | 0.46 |
| Comparative Example | 570 | −2 | 1.14 | 0.78 | 0.68 |
| C2 | | | | | |
| Comparative Example | 580 | +8 | 1.13 | 0.78 | 0.69 |
| C3 | | | | | |
| Example D1 | 550 | −22 | 1.14 | 0.44 | 0.38 |
| Example D2 | | | 1.14 | 0.45 | 0.39 |
| Example E1 | 550 | −22 | 1.14 | 0.41 | 0.36 |
| Example E2 | | | 1.14 | 0.41 | 0.36 |
| Comparative Example | | | 1.14 | 0.58 | 0.51 |
| E1 | | | | | |
| Comparative Example | | | 1.14 | 0.58 | 0.51 |
| E2 | | | | | |
| Comparative Example | | | 1.11 | 0.57 | 0.51 |
| E3 | | | | | |
| Comparative Example | — | — | 1.38 | 2.50 | 1.81 |
| F1 | | | | | |
| Example F1 | 550 | −17 | 1.38 | 0.61 | 0.44 |
| Comparative Example | — | — | 1.24 | 0.80 | 0.65 |
| F2 | | | | | |
| Example F2 | 550 | −15 | 1.24 | 0.42 | 0.34 |
| Comparative Example | — | — | 1.08 | 1.78 | 1.65 |
| F3 | | | | | |
| Comparative Example | 550 | −5 | 1.08 | 1.78 | 1.65 |
| F4 | | | | | |
| Example F3 | 530 | −25 | 1.08 | 0.51 | 0.47 |

In Table 1, among the samples using the alloy 1, samples in Comparative Examples A1 to A2, Examples A1 to A6, Comparative Examples C1 to C3, Examples C1 to C4, and Examples D1 to D2 are, the groove-formed samples, samples in Comparative Examples B1 to B3, and Examples B1 to B5 are the roughness-imparted samples, and samples in Examples E1 to E2, and Comparative Examples E1 to E3 are the core-height-limited samples. In Comparative Example 0, an unprocessed alloy ribbon in which neither formation of a groove-shaped recessed portion nor roughness imparting was performed was used, and the height of the wound core was set to 10 mm as in the case of other groove-formed samples and roughness-imparted samples.

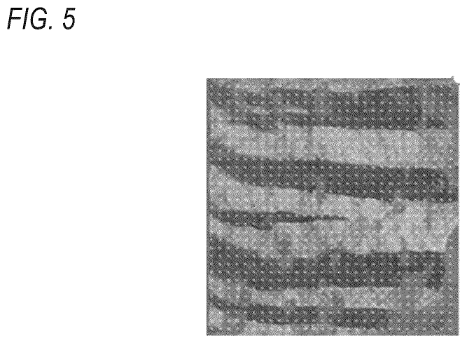

Among the above samples, in each of Examples A1 to A6, Examples B1 to B5, Examples C1 to C4, and Examples D1 to D2, the alloy ribbon has the depth of the recessed portion of 3 μm or more in the groove-formed sample or the alloy ribbon has the maximum height roughness Rz in the width direction of 3 μm or more in the roughness-imparted sample, and the alloy ribbon is subjected to anneal in a magnetic field at a temperature that is (a Curie point—200° C.) or higher and lower than the Curie point while applying a magnetic field in the width direction. In Examples E1 and E2, the height of the wound core of the core-height-limited sample is 2.5 mm or less, the annealing in a magnetic field is performed at a temperature that is (a Curie point—200° C.) or higher and lower than the Curie point while applying a magnetic field in the height direction. In each of these Examples, the ratio Pcv/Bs of the iron loss to the saturation magnetic flux density is less than 0.50, and both a high saturation magnetic flux density and a low iron loss are achieved. In these samples, it is considered that the magnetic domain subdivided through the annealing in a magnetic field is formed along the width direction of the alloy ribbon and the height direction of the wound core. In addition, FIG. 5 shows a magnetic domain observation image of the sample in Example C4, and it is found that the magnetic domain develops along a horizontal direction of the image corresponding to the width direction of the alloy ribbon and the magnetic domain is subdivided in the longitudinal direction of the alloy ribbon corresponding to a vertical direction of the image.

In Comparative Example 0, Comparative Examples A1 to A2, Examples A1 to A6, Comparative Examples B1 to B3, and Examples B1 to B5, there is a difference in the presence or absence of the formation of the uneven structure in the alloy ribbon and/or the size of the uneven structure (the depth of the recessed portion and the maximum height roughness Rz). In addition, in Examples E1 to E2, and Comparative Examples E1 to E3, there is a difference in the height of the wound core. In Comparative Example 0, the unprocessed alloy ribbon in which no uneven structure is formed is used, and the maximum height roughness Rz in the width direction of the entire surface is less than 3 μm. In Comparative Examples A1 and A2 and Comparative Examples B1 to B3, the depth of the recessed portion in the groove-formed ribbon or the maximum height roughness Rz in the width direction of the roughness-imparted ribbon is less than 3 μm. In Comparative Examples E1 to E3, the height of the wound core is more than 2.5 mm. In all of these samples in Comparative Example 0, Comparative Examples A1 and A2, Comparative Examples B1 to B3, and Comparative Examples E1 to E3, the ratio Pcv/Bs of the iron loss to the saturation magnetic flux density is 0.50 or more. It is considered that since the metal structure is continuous over a wide region along the width direction of the ribbon and the height direction of the wound core, the magnetic domain is not sufficiently subdivided, and the effect of reducing the iron loss is not sufficiently obtained.

In Comparative Examples C1 to C3, and Examples C1 to C4, there is a difference in the holding temperatures in performing the annealing in a magnetic field. In Comparative Example C3, the holding temperature is higher than the Curie point. In Comparative Example C2, the holding temperature is substantially the same as the Curie point. In samples in Comparative Examples C2 and C3, the ratio Pcv/Bs of the iron loss to the saturation magnetic flux density is 0.50 or more. On the contrary, in Comparative Example C1, the holding temperature is lower than the temperature of (a Curie point—200° C.). In the sample in Comparative Example C1, the ratio Pcv/Bs of the iron loss to the saturation magnetic flux density is 0.50 or more. In any case of Comparative Examples C1 to C3, it is considered that magnetic anisotropy is not effectively imparted during the annealing in a magnetic field, and the magnetic domain is not effectively subdivided.

Among the groove-formed samples using the alloy 1, Example A3 and Examples D1 and D2 are different in the method for forming the groove-shaped recessed portion. However, in any case, the ratio Pcv/Bs of the iron loss to the saturation magnetic flux density is reduced to the same extent, and the iron loss is effectively reduced.

All of the samples described above are samples using the alloy 1, and there is a difference in alloy kind among Comparative Examples F1 to F4 and among Examples F1 to F3. Even in the case of using any of the alloys, in Examples F1 to F3 in which a recessed portion having a depth of 3 μm or more is formed and then annealing in a magnetic field is performed at a temperature that is (a Curie point—200° C.) or higher and lower than the Curie point while applying a magnetic field in the width direction of the ribbon, the ratio Pcv/Bs of the iron loss to the saturation magnetic flux density is less than 0.50, and the iron loss is effectively reduced. In Comparative Example F1 using alloy 2, Comparative Example F2 using alloy 3, and Comparative Examples using alloy 4, no annealing in a magnetic field is performed, and the ratio Pcv/Bs is 0.50 or more in these samples. As can be seen from this, the reduction of the iron loss is not sufficiently achieved by the effect of only the alloy composition and the formation of the recessed portion, and the annealing in a magnetic field performed at a temperature that is (a Curie point—200° C.) or higher and lower than the Curie point while applying a magnetic field in the width direction is required. In Comparative Example F4, since the holding temperature is substantially the same as the Curie point, the ratio Pcv/Bs of the iron loss to the saturation magnetic flux density is 0.50 or more.

The embodiments and Examples of the present invention have been described above. The present invention is not particularly limited to these embodiments and Examples, and various modifications may be made.

The present application is based on Japanese Patent Application No. 2024-155523 filed on Sep. 10, 2024, and the contents thereof are incorporated herein by reference.

### REFERENCE SIGNS LIST

1: Recessed portion
11: Side surface portion
21: Mountain
22: Valley
d: Depth
t: Height
H: Magnetic field
L: Longitudinal direction
W: Width direction

What is claimed is:

1. An Fe-based nanocrystalline alloy ribbon, the ribbon comprising an uneven structure on a surface of the ribbon,
wherein the uneven structure comprises at least one recessed portion that extends along a longitudinal direction of the ribbon and that has a depth of 3 μm or more, and
the ribbon comprises a magnetic domain that is formed along a width direction intersecting the longitudinal direction.

2. An Fe-based nanocrystalline alloy ribbon, the ribbon comprising an uneven structure on a surface of the ribbon,
wherein the uneven structure has a maximum height roughness Rz of 3 μm or more in a width direction of the ribbon, and
the ribbon comprises a magnetic domain that is formed along the width direction.

3. The Fe-based nanocrystalline alloy ribbon according to claim 1, wherein the magnetic domain is divided in the width direction by the uneven structure.

4. The Fe-based nanocrystalline alloy ribbon according to claim 2, wherein the magnetic domain is divided in the width direction by the uneven structure.

5. A wound core comprising:
the Fe-based nanocrystalline alloy ribbon according to claim 1 that is wound into an annular shape along the longitudinal direction of the ribbon.

6. A wound core comprising:
the Fe-based nanocrystalline alloy ribbon according to claim 2 that is wound into an annular shape along a longitudinal direction of the ribbon.

7. A wound core comprising:
an Fe-based nanocrystalline alloy ribbon, wherein
the wound core comprises a region where the ribbon is continuous along a height direction of the wound core,
the region has a width of 2.5 mm or less, and
the wound core comprises a magnetic domain that is formed along the height direction of the wound core.

8. The wound core according to claim 7, having a height of 2.5 mm or less.

9. A wound core comprising:
the wound core according to claim 7 as a unit core, wherein
a plurality of the unit cores are stacked in a height direction of the wound core.

10. A wound core comprising:
the wound core according to claim 8 as a unit core, wherein
a plurality of the unit cores are stacked in a height direction of the wound core.

11. The Fe-based nanocrystalline alloy ribbon according to claim 1, wherein the ribbon comprises crystal grains having an average grain diameter of 30 nm or less.

12. The Fe-based nanocrystalline alloy ribbon according to claim 2, wherein the ribbon comprises crystal grains having an average grain diameter of 30 nm or less.

13. The wound core according to claim 7, wherein the ribbon comprises crystal grains having an average grain diameter of 30 nm or less.

14. The wound core according to claim 8, wherein the ribbon comprises crystal grains having an average grain diameter of 30 nm or less.
